(19) United States
(12) Patent Application Publication
(10) Pub. No.: US 2018/0046760 A1
(43) Pub. Date: Feb. 15, 2018

(54) DATA MANAGEMENT DEVICE AND IMAGE DISPLAY SYSTEM

(71) Applicant: Konica Minolta, Inc., Tokyo (JP)

(72) Inventors: Kenichirou SUZUKI, Tokyo (JP); Takao SHIIBASHI, Tokyo (JP); Akira KURAHASHI, Tokyo (JP)

(21) Appl. No.: 15/672,781

(22) Filed: Aug. 9, 2017

(30) Foreign Application Priority Data
Aug. 10, 2016 (JP) 2016-157131

(51) Int. Cl. G06F 19/00

(52) U.S. Cl. CPC G06F 19/321; G06F 3/0488

(57) ABSTRACT

A data management device communicably connected to a terminal device that displays an image on a web browser, includes: a hardware processor that: separates a domain to which the terminal device is connected into a plurality of subdomains; when receiving an execution request of image processing corresponding to the number divisions of image data from the terminal device, divides the image data into the number of divisions and performs image processing in a plurality of regions specified by the domain; and a transmitter that transmits the processed image data undergone the image processing by the hardware processor.

### CROSS-REFERENCE TO RELATED APPLICATIONS

The present invention claims priority under 35 U.S.C. § 119 to Japanese Patent Application No. 2016-157131 filed on Aug. 10, 2016, including description, claims, drawings, and abstract the entire disclosure are incorporated herein by reference in its entirety.

### BACKGROUND

### Technological Field

The present invention relates to a data management device and an image display system.

### Description of the Related art

In medical facilities such as hospitals, servers manage medical image data picked up by modalities (image pick-up apparatuses) such as computed radiography (CR), computed tomography (CT), magnetic resonance imaging (MRI), etc., and medical images based on the medical image data are displayed by image display devices in accordance with needs.

When medical images are to be displayed, a large amount of data has to be processed, and many techniques have been proposed to increase the processing speed thereof. For example, JP 4861647 B2 discloses a technique of dividing and processing image data by a plurality of image processing units in a computer device connected to a modality and displaying the image by a monitor or the like of a work station.

Meanwhile, in recent years, in order to enable viewing of medical images by doctors, etc. even in a place without a dedicated apparatus capable of displaying medical images, there is a demand to display medical images via a web browser installed in a terminal device such as a general personal computer (PC) or a smartphone.

However, when a medical image is to be displayed, a processing request corresponding to one image is divided and given from the terminal device to the data management device. However, due to restrictions of the web browser, there is a limit to the number of requests that can be requested simultaneously, and the data management device cannot perform efficient division processing.

For this reason, when such a terminal device is used, it takes time until the image is displayed after a user issues an instruction to display the medical image from the terminal device.

### SUMMARY

It is an object of the present invention to provide a data management device and an image display system.

To achieve the abovementioned object, according to an aspect of the present invention, a data management device communicably connected to a terminal device that displays an image on a web browser, reflecting one aspect of the present invention comprises: a hardware processor that: separates a domain to which the terminal device is connected into a plurality of subdomains; when receiving an execution request of image processing corresponding to the number divisions of image data from the terminal device, divides the image data into the number of divisions and performs image processing in a plurality of regions specified by the domain; and a transmitter that transmits the processed image data undergone the image processing by the hardware processor.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic configuration diagram of an image display system of an embodiment;

FIG. 2 is a block diagram showing a functional configuration example of a data management device;

FIG. 3 is a block diagram showing an example of a functional configuration of a terminal device;

FIG. 4 is a ladder chart showing image display processing according to the embodiment; and

FIG. 5 is a diagram for describing the image display processing of FIG. 4.

### DETAILED DESCRIPTION OF EMBODIMENTS

Hereinafter, one or more embodiments of the present invention will be described in detail with reference to the drawings. However, the scope of the invention is not limited to the disclosed embodiments.

[Configuration of Image Display System]

First, a configuration of an image display system 100 according to the embodiment will be described.

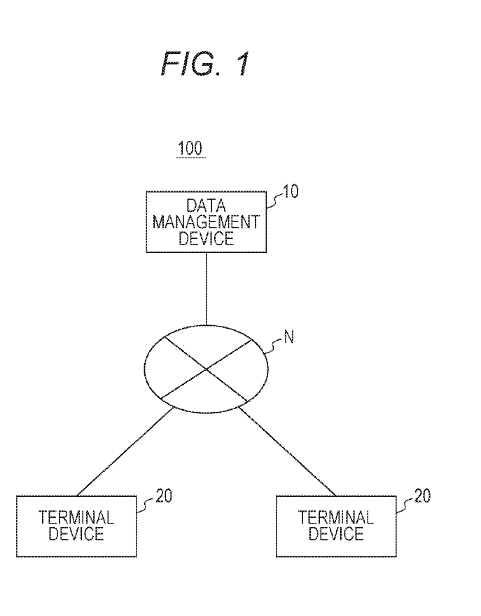

FIG. 1 is a schematic configuration diagram of the image display system 100 according to the embodiment.

As shown in FIG. 1, the image display system 100 includes: a data management device 10 and terminal devices 20 usable by, for example, users such as doctors, nurses, and visiting care workers belonging to facilities such as hospitals, clinics, and visiting nursing care offices. The data management device 10 and the terminal device 20 are connectable via a communication network N.

The data management device 10 accumulates and manages image data (hereinafter, simply referred to as “image data”) of medical images generated by a modality(ies) not shown, generates medical images in a format read by a web browser based on requests from the terminal device 20, and provides the medical images to the terminal device 20.

The data management device 10 may be a cloud server provided in a cloud environment.

The terminal device 20 is an information processing terminal capable of executing a web browser and displays medical image by using the web browser.

The terminal device 20 is, for example, a personal computer (PC), a tablet terminal, a smartphone, or the like used in each facility or the home of a patient who is under treatment at home.

[Configuration of Data Management Device]

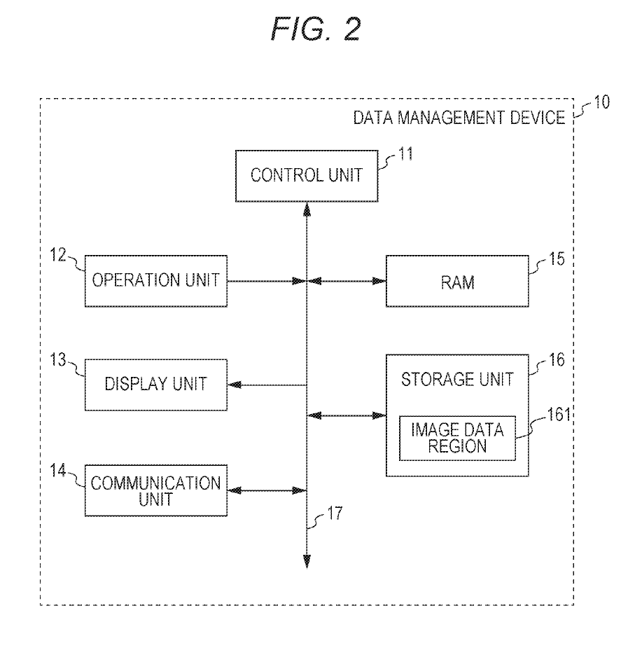

FIG. 2 is a block diagram showing an example of a functional configuration of the data management device 10.

As shown in FIG. 2, the data management device 10 includes: a control unit 11 as a domain separator, a division-number presenter, and an image processor; an operation unit 12; a display unit 13; a communication unit 14 as a transmitter; a RAM 15; a storage unit 16; etc., and each unit is connected by a bus 17.

The control unit 11 includes, for example, a central processing unit (CPU) and totally controls processing operations of each unit of the data management device 10. Specifically, the CPU reads various processing programs stored in the storage unit 16 in accordance with operation signals input from the operation unit 12 or instruction signals received by the communication unit 14, expands the programs in the RAM 15, and performs various processing in cooperation with the programs.

The operation unit 12 includes a keyboard having a cursor key, character input keys, various function keys, etc. and a pointing device such as a mouse, and the operation signals input by a key operation on the keyboard or a mouse operation are output to the control unit 11. Furthermore, the operation unit 12 may be constituted by a touch panel stacked on the display unit 13 so that an operation signal corresponding to the position of a touch operation by the operator's finger or the like is output to the control unit 11.

The display unit 13 includes a monitor such as a liquid crystal display (LCD) and displays various screens according to instructions of display signals input from the control unit 11.

The communication unit 14 includes, for example, a network interface and exchanges data with an external device connected via a communication network N such as local area network (LAN), wide area network (WAN), or the Internet.

The RAM 15 forms a work area for temporarily storing various programs, input or output data, parameters, etc. read from the storage unit 16 in various processing executed and controlled by the control unit 11.

The storage unit 16 includes, for example, a hard disk drive (HDD) or a semiconductor nonvolatile memory and stores various processing programs and parameters and files, which are necessary for executing the programs, etc. For example, the storage unit 16 stores, for example, a web server program, which is for realizing a function as a web server that communicates with a web browser installed in the terminal device 20 by using a HTTP protocol, and stores an application program that operates on the web server and provides medical images to the user of the terminal device 20 via the web browser.

Furthermore, the storage unit 16 has an image data region 161. The image data region 161 is a database generated by a modality not shown and used for managing image data transmitted from the modality. For example, predetermined accompanying information such as a patient name, an inspection type, date, etc. are attached to the image data so that each image data can be identified.

[Configuration of Terminal Device]

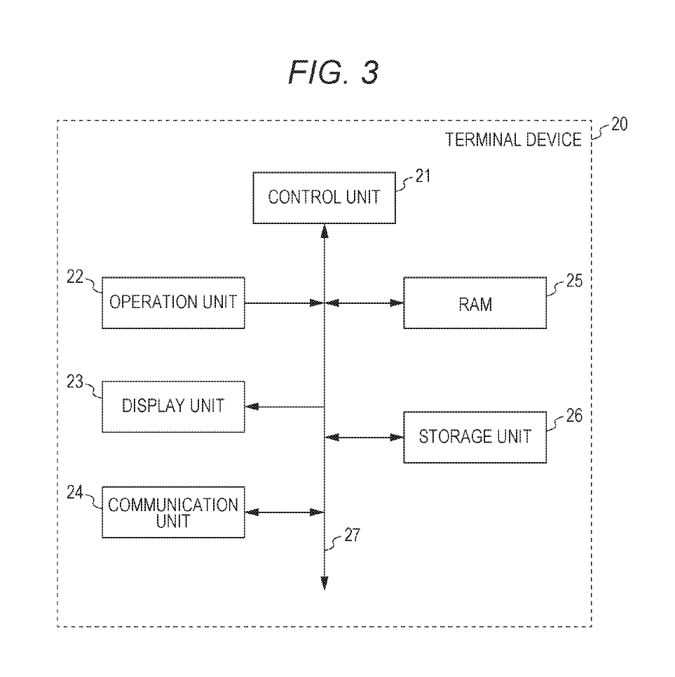

FIG. 3 is a block diagram showing an example of a functional configuration of the terminal device 20.

As shown in FIG. 3, the terminal device 20 includes: a control unit 21, an operation unit 22, a display unit 23 as a display, a communication unit 24 as a communicator, a RAM 25, a storage unit 26, etc., and each unit is connected by a bus 27.

The control unit 21 includes, for example, a CPU and totally controls the processing operations of each unit of the terminal device 20. Specifically, the CPU reads various processing programs stored in the storage unit 26 in accordance with operation signals input from the operation unit 22 or instruction signals received by the communication unit 24, expands the programs in the RAM 25, and performs various processing in cooperation with the programs.

The operation unit 22 includes a keyboard having a cursor key, character input keys, various function keys, etc. and a pointing device such as a mouse, and the operation signals input by a key operation on the keyboard or a mouse operation are output to the control unit 21. Furthermore, the operation unit 22 may be constituted by a touch panel stacked on the display unit 23 so that an operation signal corresponding to the position of a touch operation by the operator's finger or the like is output to the control unit 21.

The display unit 23 includes a monitor such as an LCD and displays various screens according to instructions of display signals input from the control unit 21. For example, the display unit 23 displays various web screens based on display data of various web screens received from the data management device 10.

The communication unit 24 includes, for example, a network interface and transmits/receives data to/from an external device connected via the communication network N such as LAN, WAN, or the Internet. In addition, the communication unit 24 may perform wireless communication by using a mobile phone line or the like and transmit/receive data to/from an external device connected via the communication network N.

The RAM 25 forms a work area for temporarily storing various programs, input or output data, parameters, etc. read from the storage unit 26 in various processing executed and controlled by the control unit 21.

The storage unit 26 includes, for example, a HDD or a semiconductor nonvolatile memory and stores various processing programs and parameters and files, which are necessary for executing the programs, etc. For example, a web browser program or the like for realizing a web browser is stored in the storage unit 26.

[Operation in Image Display System]

Next, operations of the image display system 100 will be described.

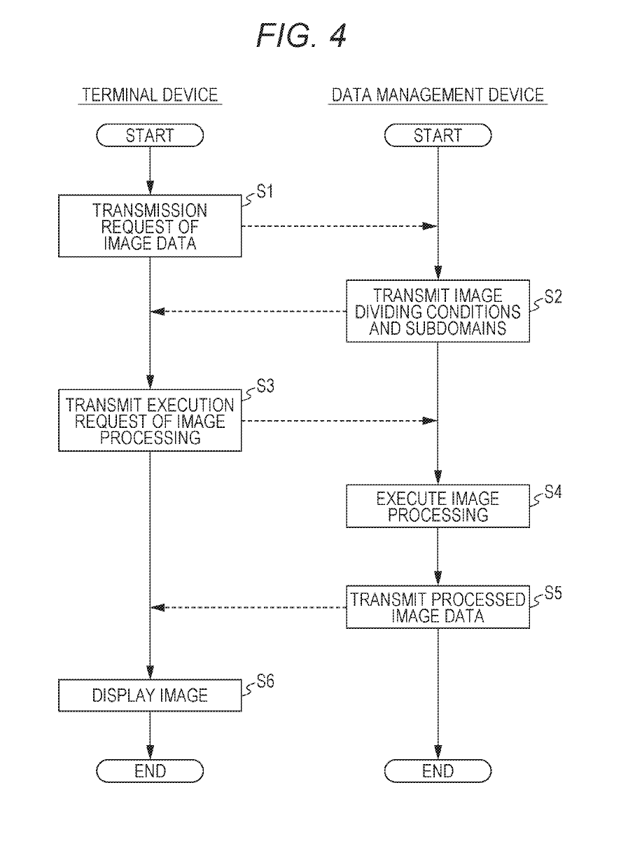

FIG. 4 is a ladder chart showing image display processing executed when a medical image is displayed by the terminal device 20 in the image display system 100.

The processing in the data management device 10 is realized by software processing in cooperation with the control unit 11 and the programs stored in the storage unit 16, and the processing in the terminal device 20 is realized by software processing in cooperation with the control unit 21 and the programs stored in the storage unit 26.

First, when a user inputs an instruction to display a predetermined medical image by the display unit 23 via the operation unit 22, the control unit 21 of the terminal device 20 transmits a transmission request of image data of a predetermined medical image to the data management device 10 (step S1).

Specifically, a list screen displaying a list of, for example, patient names and/or inspection types is displayed by the display unit 23, and the user specifies a desired patient name and/or inspection type so that, for example, the control unit 21 can transmit a transmission request of image data of a case in which a predetermined medical image is displayed. In this case, by specifying the patient name and/or the inspection type, the image data stored in the image data region 161 is specified in the data management device 10.

Alternatively, the control unit 21 may transmit a transmission request of image data by displaying, for example, a thumbnail screen of a medical image by the display unit 23 and specifying one image on the thumbnail screen by the user.

Then, when the transmission request of the image data from the terminal device 20 is received, in response to this, the control unit 11 of the data management device 10 transmits image dividing conditions and subdomains to the terminal device 20 (step S2).

Herein, in the embodiment, the control unit 11 of the data management device 10 divides the image data into a plurality of parts, performs image processing for each part, and executes processing of transmitting the divided image data, which has undergone the image processing, to the terminal device 20.

The image dividing conditions are the conditions indicating the number of divisions (the number of divisions) of the image data and the position (coordinate value) at which the image data is divided prior to the execution of such image processing for each part.

The image dividing conditions are determined by, for example, the size of an image display region of the terminal device 20 specified by the transmission request of the image data from the terminal device 20 and an image condition(s) of the image data specified by the transmission request. The image condition(s) includes at least one of the size and resolution of the image data. It should be noted that the image dividing conditions may be determined depending on the type of image processing to be performed on the image data.

For example, a breast image captured by a mammography apparatus is generally three times higher in resolution than a chest radiographic image, and, in the case of such a high-resolution breast image, the number of divisions is larger than that of a chest radiographic image.

Specifically, for example, in a case of displaying a chest radiographic image by a smartphone having a specified size, if the image data is to be divided into three at equal intervals vertically and horizontally and to be divided into nine sections as a whole to display mammographic breast images by the same smartphone, the image data is divided into three at equal intervals vertically, divided into four at equal intervals laterally, and divided into 12 as a whole.

In this manner, the control unit 11 determines the number of divisions of the image and the coordinate value of each divided part as the image dividing conditions.

Then, the control unit 11 transmits the image dividing conditions determined in the above described manner and the subdomains separated from the domain to which the terminal device 20 is connected to the terminal device 20.

Then, when the image dividing conditions and the subdomains are received from the data management device 10, the control unit 21 of the terminal device 20 transmits an execution request of the image processing with the image dividing conditions to the subdomain destinations (step S3).

Then, the control unit 11 of the data management device 10 extracts image data from the image data region 161 and executes image processing (step S4).

Herein, the control unit 11 performs predetermined image processing (for example, interpretation image creation processing, analysis processing, etc.) on the image data and converts the image data undergone the image processing into the image data in a format read by the web browser.

In this process, the control unit 11 executes the image processing by dividing the image data extracted from the image data region 161 into the specified number at the coordinate value specified by the image dividing conditions and allocating parts thereof respectively to a plurality of regions specified by the domain and subdomains.

More specifically, the data management device 10 has the plurality of regions respectively corresponding to the domain and the subdomains, and the control unit 11 allocates the divided parts respectively to the plurality of regions and executes the image processing.

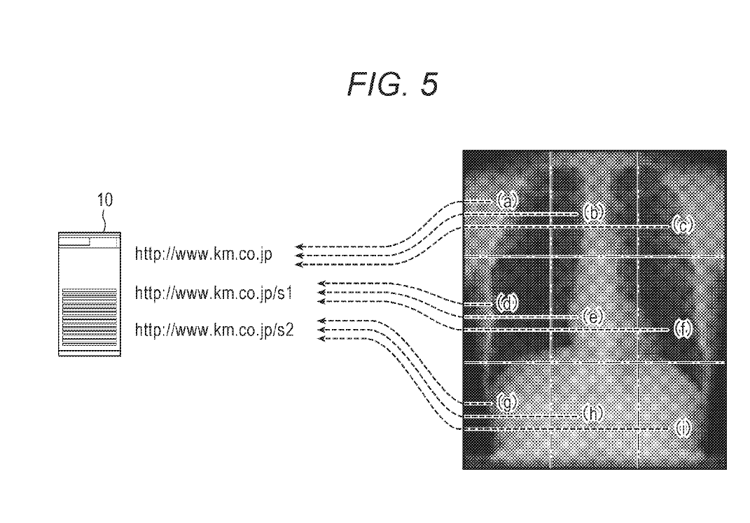

For example, the image data shown in FIG. 5 is divided into 9 parts (a) to (i), and the image parts of (a) to (c) are processed in the region to which a position in a network represented by a character string “http://www.km.co.jp/” of the uniform resource locator (URL) is allocated.

Furthermore, the image parts of (d) to (f) are processed in the region to which a position (address) in the network indicated by a character string “http://www.km.co.jp/s1” of the URL is allocated.

Moreover, the image parts of (g) to (i) are processed in the region to which a position (address) in the network indicated by a character string “http://www.km.co.jp/s2” of the URL is allocated.

It should be noted that the subdomains may be stored in the storage unit 16 in advance or may be appropriately generated. For example, if a plurality of subdomains are stored in the storage unit 16 in advance and there is a transmission request for image data by the user, the control unit 11 may read the subdomain(s) from the storage unit 16 and transmit the subdomain(s) together with the image dividing conditions. Also, if there is a transmission request for image data by the user, the control unit 11 may generate a new subdomain.

Also, the subdomain may be subjected to notification from the data management device 10 to the terminal device 20 at the timing at which the terminal device 20 and the data management device 10 are connected instead of the timing at which the data management device 10 responds to the transmission request of the image data from the terminal device 20.

In this manner, by dividing the image data and processing the parts of the divided image data in different regions, processing of the plurality of parts of the image data can be performed at the same time. As a result, the processing speed taken until the image is transmitted to and displayed by the terminal device 20 can be increased.

Then, the control unit 11 of the data management device 10 transmits the image data of the divided parts, which have undergone the image processing, to the terminal device 20 (step S5), the control unit 21 of the terminal device 20 receives the image data and displays the image data by the display unit 23 (step S6), and the present processing is terminated.

As described above, according to the embodiment, in the data management device 10 communicably connected to the terminal device 20 which displays images by the web browser, when the control unit 11 separates a domain to which the terminal device 20 is connected into a plurality of subdomains and receives an execution request of image processing corresponding to the number of divisions of the image data from the terminal device 20, the control unit 11 divides the image data into the number of divisions, performs the image processing in the plurality of regions specified by the domain and the plurality of subdomains, and transmits the processed divided image data, which has undergone the image processing, to the terminal device 20.

Therefore, by using the subdomains, the number of requests that can be simultaneously requested from the terminal device 20 to the data management device 10 can be increased, and image processing can be simultaneously performed by dividing one piece of image data into a plurality of pieces. Therefore, the processing speed is increased as a whole, and the time taken until the image(s) is displayed by the terminal device 20 can be shortened.

Furthermore, according to the embodiment, when the transmission request of image data from the terminal device 20 is received, the control unit 11 of the data management device 10 presents the number of divisions of the image data to the terminal device 20. When the execution request of image processing is received from the terminal device 20 as a result of presenting the number of divisions, the image data is divided into the number of divisions.

Therefore, in response to the transmission request of the image data from the terminal device 20, the number of divisions of the image data is presented to the terminal device 20.

Furthermore, according to the embodiment, the control unit 11 of the data management device 10 presents the number of divisions in accordance with the size of the image display region of the terminal device 20 specified by the transmission request of the image data and the image condition of the image data, and the image condition includes at least one of the size and the resolution of the image data.

Therefore, since the image data can be divided into an appropriate number according to the size of the image display region of the terminal device 20 and the image condition of the image data, the image processing can be executed more quickly.

According to the embodiment, the image data is medical image data.

Therefore, it is possible to speed up the processing of the medical image data having a large capacity and to promptly display the medical image by the terminal device 20.

It should be noted that the image data in the above embodiment may include not only still image data but also moving image data.

If the image data is moving image data, the moving image data can be divided into a predetermined number depending on the length thereof, and the number of divisions of the image, the frame number of each divided part, etc. can be determined as the image dividing conditions.

Therefore, even if the image data is moving image data, image processing can be performed quickly.

Although embodiments of the present invention have been described and illustrated in detail, it is clearly understood that the same is by way of illustration and example only and not limitation, the scope of the present invention should be interpreted by terms of the appended claims.

What is claimed is:

1. A data management device communicably connected to a terminal device that displays an image on a web browser, the data management device comprising:
a hardware processor that:
separates a domain to which the terminal device is connected into a plurality of subdomains;
when receiving an execution request of image processing corresponding to the number divisions of image data from the terminal device, divides the image data into the number of divisions and performs image processing in a plurality of regions specified by the domain; and
a transmitter that transmits the processed image data undergone the image processing by the hardware processor.

2. The data management device according to claim 1, comprising
the hardware processor that, if a transmission request of the image data is received from the terminal device, presents the number of divisions of the image data to the terminal device, wherein,
when the hardware processor receives the execution request of the image processing from the terminal device as a result of presenting the number of divisions by the hardware processor, the hardware processor divides the image data into the number of divisions.

3. The data management device according to claim 2, wherein
the hardware processor presents the number of divisions in accordance with a size of an image display region of the terminal device and an image condition of the image data specified by the transmission request of the image data, and
the image condition includes at least one of a size and resolution of the image data.

4. The data management device according to claim 1, wherein the image data is medical image data.

5. The data management device according to claim 1, wherein the image data includes moving image data.

6. An image display system comprising:
the data management device according to claim 1; and
a terminal device that displays an image on a web browser and is communicably connected to the data management device, wherein
the terminal device includes
a communicator that transmits the execution request of the image processing corresponding to the number of divisions of the image data to the data management device and receives the processed divided image data from the data management device, and
a display that displays the image based on the image data received by the communicator.
